(19) United States
(12) Patent Application Publication
(10) Pub. No.: US 2024/0302832 A1
(43) Pub. Date: Sep. 12, 2024

(54) Training Prediction Models for Predicting Undesired Events During Execution of a Process

(71) Applicant: ABB Schweiz AG, Baden (CH)

(72) Inventors: Hadil Abukwaik, Weinheim (DE); Divyasheel Sharma, Bangalore (IN); Benjamin Kloepper, Mannheim (DE); Arzam Muzaffar Kotriwala, Ladenburg (DE); Pablo Rodriguez, Birkenau (DE); Benedikt Schmidt, Heidelberg (DE); Ruomu Tan, Mannheim (DE); Chandrika K R, Bangalore (IN); Reuben Borrison, Brühl (DE); Marcel Dix, Allensbach (DE); Jens Doppelhamer, Ladenburg (DE)

(73) Assignee: ABB Schweiz AG, Baden (CH)

(21) Appl. No.: 18/668,370

(22) Filed: May 20, 2024

Related U.S. Application Data
(63) Continuation of application No. PCT/EP2022/080267, filed on Oct. 28, 2022.

(30) Foreign Application Priority Data
Nov. 22, 2021 (EP) 21209620.0

(51) Int. Cl. G05B 23/02

(52) U.S. Cl. CPC G05B 23/0254; G05B 23/027; G05B 23/0286

(57) ABSTRACT

A method for training a prediction model includes obtaining training samples representing states of the process that do not cause the undesired event; obtaining based on a process model and a set of predetermined rules that stipulate states having an increased likelihood of the undesired event occurring; training samples representing states with an increased likelihood to cause the undesired event; providing samples to the to-be-trained prediction model to obtain a prediction of the likelihood for occurrence of the undesired event in a state of the process represented by the respective sample; rating a difference between the prediction and the label of the respective sample using a predetermined loss function; and optimizing parameters such that, when predictions are made, the rating by the loss function improves.

### CROSS-REFERENCE TO RELATED APPLICATIONS

The instant application claims priority to International Patent Application No. PCT/EP2022/080267, filed Oct. 28, 2022, and to European Patent Application No. 21209620.0, filed Nov. 22, 2021, each of which is incorporated herein in its entirety by reference.

### FIELD OF THE DISCLOSURE

The present disclosure generally relates to improving the execution of processes on industrial plants and/or electric networks so as to reduce the likelihood of at least one undesired event occurring.

### BACKGROUND OF THE INVENTION

Industrial plants for the execution of industrial processes, as well as electric networks, are protected by interlock conditions. Such interlock conditions are very frequently used on equipment to guard against operator errors, like grounding an electric circuit while it is at the same time energized by the power source (thereby shorting out the power source to ground). For the execution of processes in the plant or network, there are more safety interlock rules that enforce certain limits on state variables or other variables of the plant. For example, if a pressure gauge of a vacuum chamber that houses a materials processing equipment registers an increase in the pressure beyond what is acceptable for the system, the equipment may be turned off, so as to prevent damage to the system.

Safety interlock rules frequently dictate drastic countermeasures against an unsafe state. For example, the plant or a part thereof may be brutally cut off from the power supply, irrespective of how tedious or difficult it then becomes to get the process up and running again. For example, turning off the heat in a chemical reaction vessel may cause its liquid contents to cool down and solidify. Using the reaction vessel again then requires a laborious manual removal using hammers and chisels at best, and is impossible at worst. The triggering of a safety interlock event may therefore be a major setback.

### BRIEF SUMMARY OF THE INVENTION

The present disclosure aims in reducing the occurrence of safety interlock events by allowing to predict the occurrence of such events, and/or by actively avoiding those events based on such a prediction. Embodiments of the disclosure describe a method for training a prediction model for predicting the likelihood that at least one predetermined undesired event will occur during execution of a process. The process may be an industrial process that is executed in an industrial plant, such as a chemical process that converts one or more educts into one or more products by at least one chemical reaction. The process may also be an electrical process in an electric network, such as operation of an electric power grid. This method uses training samples with data that characterizes a state of the industrial process.

In the course of the method, training samples representing states of the process that do not cause the undesired event are obtained. Operation without undesired events occurring is the normal operating state of the plant or network; therefore, such training samples are in plentiful supply. The training samples are labelled with a pre-set low likelihood of the undesired event occurring, depending on the scale on which this likelihood is measured. For example, if the likelihood is measured as a probability, it may be set to a very low non-zero value, rather than to zero, to avoid any divide-by-zero errors at runtime.

That undesired events are fortunately rare, or do not occur at all, during normal operation of the plant or network is tied to the misfortune that very little (if any) training samples for states of the process that trigger such an undesired event are available. That is, the set of training samples is strongly imbalanced towards training samples representing normal operation. In order to train a prediction model to reliably predict the likelihood of an undesired event, a more balanced set of training samples is needed.

To this end, based at least in part on a process model and a set of predetermined rules that stipulate in which states of the process there is an increased likelihood of the undesired event occurring, further training samples are obtained. These further training samples represent states of the process with an increased likelihood to cause the undesired event, and are consequently labelled with this increased likelihood.

### BRIEF DESCRIPTION OF THE SEVERAL VIEWS OF THE DRAWING(S)

FIG. 1 is a flowchart for a method in accordance with the disclosure.

FIG. 2 is another exemplary embodiment in accordance with the disclosure.

FIG. 3 is an exemplary embodiment of a system and platform in accordance with the disclosure.

### DETAILED DESCRIPTION OF THE INVENTION

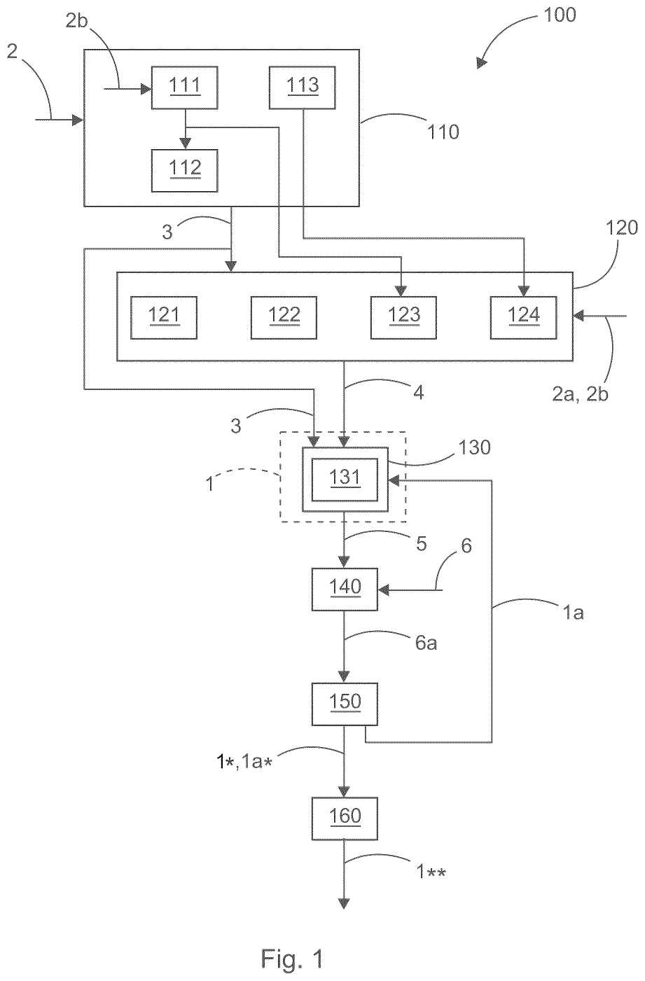

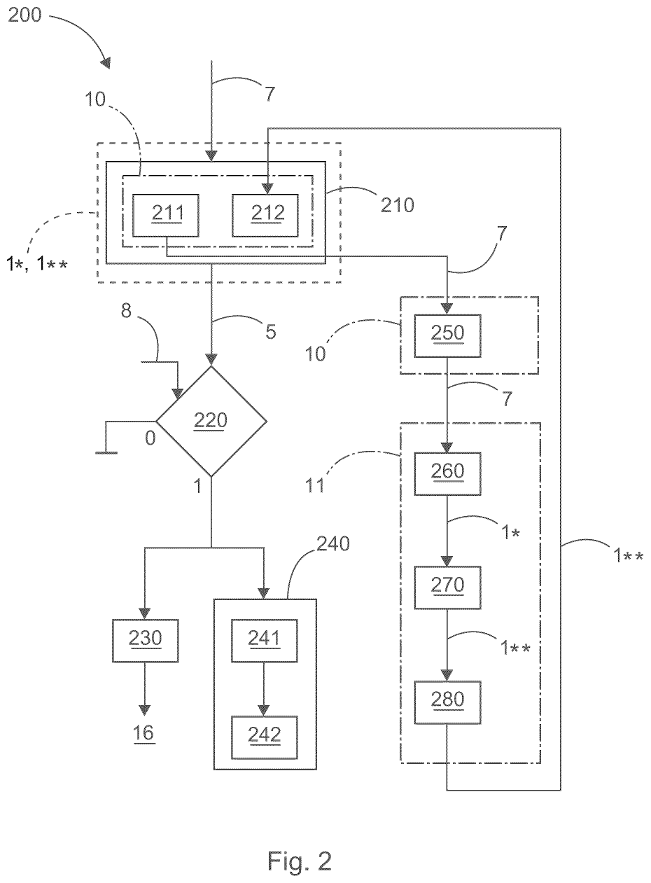

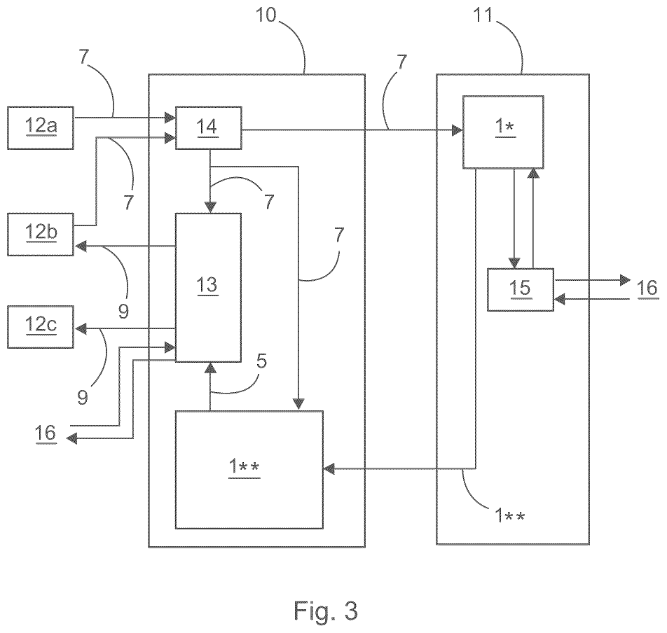

FIG. 1 is an exemplary embodiment of the method 100 for training a prediction model; FIG. 2 is an exemplary embodiment of the method 200 for executing a process; FIG. 3 is an exemplary arrangement of an edge system and a cloud platform for keeping a surrogate approximation of a prediction model updated.

FIG. 1 is a schematic flow chart of an exemplary embodiment of the method 100 for training a prediction model 1. The prediction model 1 is to predict a likelihood that at least one predetermined undesired event will occur during execution of a process 2.

In step 110, training samples 3 are obtained. These training samples 3 represent states of the process 2 that do not cause the undesired event. They are labelled with a pre-set low likelihood of the undesired event occurring.

In step 120, based at least in part on a process model 2a and a set of predetermined rules 2b that stipulate in which states of the process 2 there is an increased likelihood of the undesired event occurring, further training samples 4 are obtained. These further training samples 4 represent states of the process with an increased likelihood to cause the undesired event. They are therefore labelled with this increased likelihood.

In step 130, the training samples 3, 4 are provided to the to-be-trained prediction model 1. The prediction model 1 then outputs a prediction 5 of the likelihood for occurrence of the undesired event in a state of the process 2 that is represented by the respective sample 3, 4.

In step 140, a difference between the prediction 5 and the label of the respective sample 3, 4 is rated by means of a predetermined loss function 6. The loss function 6 yields a rating 6a.

In step 150, parameters la that characterize the behavior of the prediction model 1 are optimized such that, when predictions 5 on further samples 3, 4 are made, the rating 6a by the loss function 6 is likely to improve. The finally trained state of the parameters 1a is labelled with the reference sign 1a*. These finally optimized parameters 1a* characterize the behavior of the fully trained prediction model that is labelled with the reference sign 1*.

In step 160, the behavior of the trained prediction model 1* is approximated by means of a surrogate model 1** that is computationally cheaper to evaluate than the trained prediction model 1*.

According to block 111, it may be determined, based at least in part on the predetermined rules 2b, which of the variables that characterize the state of the process 2 have an impact on the likelihood of the undesired event occurring. These variables, and/or processing results obtained from these variables, may then be included in the training samples 3 according to block 112, and in the training samples 4 according to block 123.

According to block 113, respectively 124, at least one statistical moment, and/or a time series, of at least one state variable of the process 2, may be included in the training samples 3, respectively 4.

According to block 121, the process model 2a may be specifically configured to predict a future evolution of the state of the process 2 based on at least one current and/or past state of the process 2.

According to block 122, the process model 2a may comprise: a machine learning model; and/or a simulation model; and/or a surrogate approximation of this simulation model.

According to block 131, the prediction model 1 may produce a prediction 5 of the likelihood for occurrence of the undesired event at the end of a predetermined time window based on samples 3, 4 within this time window.

FIG. 2 is a schematic flow chart of an exemplary embodiment of the method 200 for executing a process 2 on at least one industrial plant or in at least one electric network.

In step 210, one or more samples 7 representing a state of the process 2 are provided to a trained prediction model 1*, and/or to a surrogate approximation 1** thereof. The trained prediction model 1*, respectively the surrogate approximation 1**, then outputs a prediction 5 of the likelihood for occurrence of the undesired event in a state of the process 2 represented by the one or more samples.

In step 220, the prediction 5 is tested against at least one predetermined criterion 8.

If the criterion 8 is met (truth value 1), in step 230, an alarm may be outputted to an operator 16 of the process 2. Alternatively or in combination to this, in step 240, the execution of the process 2 may be modified with the goal of reducing the likelihood for occurrence of the undesired event.

According to block 211, samples representing states of the process 2 may be collected by an edge system 10 of an industrial plant or other site that participates in executing the process 2. In step 250, the edge system 10 may then provide the samples to a cloud platform 11.

In step 260, the cloud platform 11 may then train and/or update the prediction model 1 based on the samples 7 received from the edge system 10. The cloud platform 11 may then create, in step 270, a surrogate approximation 1** for the trained and/or updated prediction model 1*, and/or an update to such an approximation 1**.

This surrogate approximation 1** , and/or the update thereto, may then be provided back to the edge system 10 in step 280. On the edge system 10, this new and/or updated surrogate approximation 1 ** may then be evaluated to obtain the prediction 5, according to block 212.

FIG. 3 shows an exemplary arrangement of an edge system 10 and a cloud platform 11 that may be used for performing the method 200.

In the example shown in FIG. 3, the industrial plant executing the process 2 comprises sensors 12a, actuators 12b and controllers 12c. Sensors 12a and actuators 12bproduce samples 7 of data that is indicative of the state of the process 2. These samples are ingested and pre-processed by an edge data manager 14 of the edge system 10. They are passed on to the process control system 13, which in turn supplies control actions 9 to actuators 12b and controllers 12c to react to the state of the process 2 reflected in the samples 7.

When determining the control actions 9, the process control system 13 also considers a prediction 5 outputted by the surrogate approximation 1** as to the likelihood for occurrence of an undesired event. That is, the process control system 13 may steer, by means of the control actions 9, the process 2 in a manner that occurrence of the undesired event is avoided. Also, the process control system 13 is in communication with an operator 16 of the industrial plant.

The samples 7 are passed on to the cloud platform 11 where the trained prediction model 1* resides. They are used to further train this model 1*. After an update to the prediction model 1*, the cloud platform 11 also generates a corresponding update to the surrogate approximation 1**. This update is passed back to the edge system 10.

The cloud platform 11 also comprises an operational safety interface 15 by which it is in communication with the operator 16 of the plant.

The process model may be a monolithic model of the process as a whole, but it may also be composed of sub-models at any desired level of granularity. For example, different sub-models may predict the future development of different aspects of the state of the process, which may correspond to different sub-units of the plant or network. For the sake of clarity, reference will be made to just one process model in the following.

In particular, the process model may be specifically configured to predict a future evolution of the state of the process based on at least one current and/or past state of the process. The so-predicted future states may then, for example, be checked against the predetermined rules for the occurrence of the undesired event. If the predicted evolution of the process leads to a state that, according to the predetermined rules, will cause the undesired event, then the current and/or past state from which this predicted evolution is determined may be deemed to be causal for the undesired event.

Preferably, the process model may comprise a machine learning model; and/or a simulation model; and/or a surrogate approximation of this simulation model.

Which type of process model is most advantageous depends on how much knowledge about the inner workings of the process (or any part thereof) is available. For example, if the process is a “black box”, a machine learning model may be trained on inputs to this “black box” and outputs obtained in response, without a need to dive deeper into the inner workings of the process. If the inner workings of the process are well known and understood, a simulation model of the process based on that knowledge about the process may be used.

Simulation models can predict the future evolution of the process with a high fidelity. However, this comes at the price that a simulation model may be expensive to compute. The complex computations may take several hours or even more. For avoiding undesired events during the real-time execution of the process, however, being able to obtain results faster is more important than the highest level of fidelity.

This is where a surrogate approximation of the simulation model may save large amounts of computation time. In return for a small sacrifice in fidelity, the computation may be speeded up so much that it can be even much faster than real-time. This in turn allows to compute multiple scenarios and explore multiple possible paths on which the process may evolve, depending on the action taken now. This is somewhat akin to the lossy compression of audio and video data that takes away some of the quality but reduces the bandwidth requirement so much that the data may be streamed in real-time.

Using the process model and the set of rules, the previously scarce set of training samples for states that may trigger the undesired event may be augmented to an arbitrary extent, so as to arrive at a more balanced set of training samples. This in turn allows for a supervised training of the prediction model. In this context, exploiting the predetermined set of rules yields the further advantage that these rules provide some level of abstraction from the exact internal behavior of the real process. This exact internal behavior is not always known. For example, in an industrial plant, some equipment may be bought and used as a “black box” with abstract technical specifications without access to its inner workings. A large-scale electricity grid is composed of many sub-networks that are run by different operators, and the inner complexity of these sub-networks is hidden behind abstract specifications. Just like the Earth can be abstracted to a point mass for some astronomical calculations, a power station may boil down to a handful of quantities, such as a maximum power output and a slew rate of the power output.

In the course of the supervised training, training samples are provided to be to-be-trained prediction model. The prediction model then outputs a prediction of the likelihood for occurrence of the undesired event in a state of the process represented by the respective sample. A difference between the so-obtained prediction on the one hand, and the label of the respective sample on the other hand, is rated by means of a predetermined loss function (or “cost function”). Examples of such loss functions are the cross-entropy and the log-likelihood.

Parameters that characterize the behavior of the prediction model are optimized such that, when predictions on further samples are made, the rating by the loss function is likely to improve. The training may stop in response to any suitable stopping criterion, such as the achieving of a certain prediction accuracy on the training samples, a number of training epochs, or convergence (i.e., failure of the parameters to change further). For example, in a neural network prediction model, the parameters comprise weights with which inputs to each neuron are summed to an activation of that neuron.

The predetermined rules may, for example, comprise safety interlock rules that specify under which circumstances a safety interlock event is to be triggered. Many such safety interlock rules trigger a safety interlock event in response to certain alarms being raised in the plant, and/or in response to certain state variables of the plant and/or process crossing certain pre-set thresholds. In an electric network, sub-networks are usually set to disconnect from each other if currents between them climb above hard limits. If the respective condition is met, this invariably leads to the event occurring. That is, the likelihood of the event occurring is then maximal (i.e., 1 on a scale of probabilities).

Thus, in a particularly advantageous embodiment, the undesired event comprises a safety interlock event that forces an at least partial stop and/or shutdown of the process, and/or of the industrial plant or electric network that is executing the process. Being able to predict these events, which were previously handled in a reactive manner, allows to handle them in a pro-active manner before they actually occur. For example, occurrence of these events may be avoided, and/or the consequences may be mitigated.

For other types of undesired events, the rules that connect states of the process to an increased likelihood of the event occurring may be softer. For example, each rule may carry a certain amount of “penalty points”, and if the state of the process meets multiple rules at once, these “penalty points” accrue. The undesired event may then, for example, be coupled to the condition that at least a threshold amount of “penalty points” has accrued. In such a situation, no rule stipulates on its own that the event shall occur under a certain condition, but each rule that is met increases the likelihood for the event.

The likelihood of the undesired event occurring may be measured on any suitable scale. For example, the likelihood may be measured on a scale of a probability that this event occurs. This is an easily interpretable scale. Safety requirements, for example, may stipulate that the probability for certain events needs to be below a certain threshold.

For avoiding the occurrence of undesired events in real-time process execution, another notion of the likelihood may also be advantageous: The likelihood may be measured on a scale of closeness of the state of the process to a state that causes the undesired event to occur. This gives a direct guidance as to what may be done in order to reduce the likelihood of undesired events. This is somewhat akin to the risks of drone operations being measured in terms of closeness to the operations to critical airspaces or installations on the ground.

In a further advantageous embodiment, the method further comprises determining, based at least in part on the predetermined rules, which of the variables that characterize the state of the process have an impact on the likelihood of the undesired event occurring. These variables, and/or processing results obtained from these variables, may then be included in the training samples. That is, the state variables may be pre-filtered to reduce the complexity of the prediction model.

The training samples may, for example, comprise any sort of state variables of the process. For example, in a chemical process, the state variables may comprise temperatures, concentrations or other physical properties of substances, pressures, or mass flows. In an electrical process, the state variables may comprise voltages, currents, power amounts, temperatures, or switching states of switchable connections.

In a further advantageous embodiment, at least one statistical moment, and/or a time series, of at least one state variable of the process is included in the training samples. In particular, some kinds of prediction models, such as recurrent neural networks and transformer networks, are specifically adapted to process samples comprising time series, so as to directly learn from trends evident in such time series. Statistical moments of state variables may be included in the training samples to compress the information in the state variables.

In a further particularly advantageous embodiment, the prediction model obtains a prediction of the likelihood for occurrence of the undesired event at the end of a predetermined time window based on samples within this time window. In this manner, a temporal horizon for causality may be set. Also, it is then clear how much time is remaining for any remedial actions for the purpose of avoiding the undesired event.

In a further particularly advantageous embodiment, the behavior of the trained prediction model is approximated by means of a surrogate model that is computationally cheaper to evaluate than the trained prediction model. In this manner, some of the accuracy of the prediction is traded in for obtaining the prediction faster. In particular, as discussed before, if the prediction can be obtained faster than in real-time, multiple candidate actions for avoiding the occurrence of the undesired event may be tested using the prediction model. That is, “what-if”' scenarios may be analyzed, and the best action may then be implemented on the process.

The ultimate purpose of the trained prediction model is to improve the execution of processes and pro-actively react to impending occurrences of undesired events, so as to avoid them. The invention also provides a method for executing a process on at least one industrial plant or in at least one electric network.

In the course of this method, one or more samples representing a state of the process are provided to a trained prediction model, and/or to a surrogate approximation thereof, so as to obtain a prediction of the likelihood for occurrence of the undesired event in a state of the process represented by the one or more samples.

This prediction is tested against at least one predetermined criterion. For example, this criterion may comprise a threshold value for the probability of the undesired event occurring, or for the closeness in parameter space of the current state of the process to a state that will trigger the undesired event.

In response to the criterion being met, an alarm is outputted to an operator of the process, and/or the execution of the process is modified with the goal of reducing the likelihood for occurrence of the undesired event. Such modification may entail a degradation of the execution. For example, the production rate of a product may be reduced or halted altogether, or some loads may be shed from the electric network. While it is of course most desirable to run the process without any degradation, a degradation is usually a lot more graceful than the occurrence of a safety interlocking event. For example, temporarily getting less product out of a chemical process is a far lesser evil than having to clean out solidified substance from a reactor vessel by hammer and chisel, and shedding some loads from the electric network is a lot better than losing power in the network altogether.

In a further particularly advantageous embodiment, in order to modify the execution of the process, samples representing multiple candidate states of the process that are different from the current state of the process are provided to the prediction model. This yields likelihoods for occurrence of the undesired event for the candidate states. That is, options for states towards which the process might be moved may be explored in a “what-if” manner. Execution of the process may then be steered towards a candidate state with the least likelihood of the undesired event as a target state.

Steering the process may, for example, comprise altering set-point values provided to low-level controllers of the industrial plant or electric network executing the process, and/or enabling or disabling pieces of equipment or interconnections in the plant or network.

On many sites where an industrial plant or an electric installation is working to execute a process, many Internet of Things, IOT, devices are participating in this work. These devices are communicating with an IoT edge system for the purpose of process control. This edge system has some processing power for evaluating a prediction model, but not enough processing power for training such a prediction model. But the edge system can delegate this work to a cloud platform with more processing power.

Therefore, in a further particularly advantageous embodiment, samples representing states of the process are collected by an edge system of an industrial plant or other site that participates in executing the process. The samples are provided to a cloud platform by the edge system. Based on these samples, the prediction model is trained and/or updated on the cloud platform. The cloud platform also creates a surrogate approximation for the trained and/or updated prediction model, and/or an update to such an already existing approximation. The surrogate approximation, and/or the update thereto, is provided back to the edge system. On the edge system, the surrogate approximation is evaluated, so as to obtain the prediction of the likelihood for occurrence of the undesired event.

The methods may be wholly or partially computer-implemented. The invention therefore also relates to one or more computer programs with machine-readable instructions that, when executed on one or more computers and/or compute instances, cause the one or more computers to perform one of the methods described above. In this context, a virtualization platform, a hardware controller, network infrastructure devices (such as switches, bridges, routers or wireless access points), as well as end devices in the network (such as sensors, actuators or other industrial field devices) that are able to execute machine readable instructions are to be regarded as computers as well.

The invention therefore also relates to a non-transitory storage medium, and/or to a download product, with the one or more computer programs. A download product is a product that may be sold in an online shop for immediate fulfillment by download. The invention also provides one or more computers and/or compute instances with the one or more computer programs, and/or with the one or more non-transitory machine-readable storage media and/or download products.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### List of Reference Signs:

1 prediction model
1* fully trained state of model 1
1** surrogate approximation of trained model 1*
1a parameters that characterize behavior of prediction model 1
1a* fully optimized state of parameters 1a
2 process
2a process model
2b rules for increased likelihood of undesired events
3 training samples without increased likelihood of undesired event
4 training samples with increased likelihood of undesired event
5 prediction for likelihood of undesired event
6 loss function
6a rating by loss function
7 samples acquired during execution of process 2
8 criterion for prediction 5
9 control action
10 edge system
11 cloud platform
12a sensors
12b actuators
12c controllers
13 process control system for process 2
14 edge data manager
15 operational safety interface
16 operator of industrial plant
100 method for training prediction model 1
110 obtaining training samples 3
111 determining variables with impact on likelihood of undesired event
112 including variables with impact in training samples 3
113 including statistical moment in training samples 3
120 obtaining further training samples 4
121 choosing process model 2a that predicts future state
122 choosing particular kinds of process models 2a
123 including variables with impact in further training samples 4
124 including statistical moments in further training samples 4
130 providing training samples 3, 4 to prediction model 1
131 obtaining prediction at end of time frame
140 rating difference between prediction 5 and label of sample 3, 4
150 optimizing parameters 1a
160 creating surrogate approximation 1** for trained model 1*
200 method for executing process 2
210 providing samples 7 to trained prediction model 1*
211 collecting samples by edge system 10
212 evaluating surrogate approximation 1** on edge system 10
220 testing prediction against criterion 8
230 outputting alarm to operator 16
240 modifying execution of process
241 providing samples for candidate states to prediction model 1
242 steering process to avoid undesired event
250 providing samples 7 to cloud platform 11
260 training and/or updating prediction model 1
270 creating surrogate approximation 1**
280 providing update to edge system 10

What is claimed is:

1. A method for training a prediction model for predicting the likelihood that at least one predetermined undesired event will occur during execution of a process using training samples, wherein each training sample comprises data that characterizes a state of the process, the method comprising:
obtaining training samples representing states of the process that do not cause the undesired event, and labelling these training samples with a pre-set low likelihood of the undesired event occurring;
obtaining, based at least in part on a process model and a set of predetermined rules that stipulate in which states of the process there is an increased likelihood of the undesired event occurring, further training samples representing states of the process with an increased likelihood to cause the undesired event, and labelling these training samples with said increased likelihood;
providing training samples to the to-be-trained prediction model so as to obtain, from the prediction model, a prediction of the likelihood for occurrence of the undesired event in a state of the process represented by the respective sample;
rating a difference between the prediction and the label of the respective sample utilizing a predetermined loss function; and
optimizing parameters that characterize the behavior of the prediction model, such that, when predictions on further samples are made, the rating by the loss function is likely to improve.

2. The method of claim 1, wherein the undesired event comprises a safety interlock event that forces an at least partial stop and/or shutdown of the process, and/or of the industrial plant or electric network that is executing the process.

3. The method of claim 1, wherein the likelihood of the undesired event occurring is measured on a scale of a probability that the undesired event occurs; and/or on a scale of closeness of the state of the process to a state that causes the undesired event to occur.

4. The method of claim 1, wherein the process model is specifically configured to predict a future evolution of the state of the process based on at least one current and/or past state of the process.

5. The method of claim 1, wherein the process model comprises at least one of a machine learning model; a simulation model; and/or a surrogate approximation of this simulation model.

6. The method of claim 1, further comprising determining, based at least in part on the predetermined rules, which of the variables that characterize the state of the process have an impact on the likelihood of the undesired event occurring; and including these variables, and/or processing results obtained from these variables, in the training samples.

7. The method of claim 1, further comprising including in the training samples at least one statistical moment, and/or a time series, of at least one state variable of the process.

8. The method of claim 1, further comprising obtaining, by the prediction model, a prediction of the likelihood for occurrence of the undesired event at the end of a predetermined time window based on samples within this time window.

9. The method of claim 1, further comprising approximating the behavior of the trained prediction model using a surrogate model that is computationally cheaper to evaluate than the trained prediction model.

10. A method for executing a process on at least one industrial plant or in at least one electric network, comprising:
providing one or more samples representing a state of the process to a trained prediction model and/or to a surrogate approximation thereof so as to obtain a prediction of the likelihood for occurrence of the undesired event in a state of the process represented by the one or more samples;
testing the prediction against at least one predetermined criterion; and
in response to the criterion being met, outputting an alarm to an operator of the process and/or modifying the execution of the process with the goal of reducing the likelihood for occurrence of the undesired event.

11. The method of claim 10, wherein modifying the execution of the process comprises providing samples representing multiple candidate states of the process that are different from the current state of the process to the prediction model, thereby obtaining likelihoods for occurrence of the undesired event for the candidate states; and steering execution of the process towards a candidate state with the least likelihood for occurrence of the undesired event as a target state.

12. The method of claim 11, further comprising:
collecting by an edge system of an industrial plant or other site that participates in executing the process, samples representing states of the process;
providing, by the edge system, the samples to a cloud platform;
training and/or updating on the cloud platform, based on the samples obtained from the edge system, the prediction model;
creating by the cloud platform a surrogate approximation for the trained and/or updated prediction model and/or an update to such an approximation;
providing by the cloud platform the surrogate approximation and/or the update thereto, to the edge system; and
evaluating on the edge system the surrogate approximation so as to obtain the prediction of the likelihood for occurrence of the undesired event.
